(19) United States
(12) Patent Application Publication
(10) Pub. No.: US 2009/0100237 A1
(43) Pub. Date: Apr. 16, 2009

(54) Storage system that dynamically allocates real area to virtual area in virtual volume

(75) Inventors: Daisuke Orikasa, Odawara (JP); Yutaka Takata, Ninomiya (JP); Shintaro Inoue, Odawara (JP)

Correspondence Address: Stanley P. Fisher;Reed Smith LLP, Suite1400, 3110 Fairview Park Drive, Falls Church, VA, 22042-4503, US

(73) Assignee: Hitachi, Ltd.

(21) Appl. No.: 12/068,295

(22) Filed: Feb. 5, 2008

(30) Foreign Application Priority Data
Oct. 11, 2007 (JP) 2007-265381

(51) Int. Cl. G06F 12/02

(52) U.S. Cl. 711/162; 711/E12.002

(57) ABSTRACT

Either all or part of mapping information, which is stored in a volatile memory, is written to a nonvolatile storage area. When the target of the write to the nonvolatile storage area is a portion of the mapping information, an information element required to restore the mapping information, from among a plurality of information elements constituting the mapping information, is written to the nonvolatile storage area as the portion of the mapping information.

### CROSS-REFERENCE TO PRIOR APPLICATION

This application relates to and claims the benefit of priority from Japanese Patent Application number 2007-265381, filed on Oct. 11, 2007, the entire disclosure of which is incorporated herein by reference.

### BACKGROUND

The present invention generally relates to technology for dynamically allocating a real area to a virtual area in a virtual volume that is provided to a computer.

As technology related to expanding the capacity of a logical volume, for example, the technologies disclosed in Japanese Patent Laid-open No. 2003-15915, Japanese Patent Laid-open No. 2005-234820, and Japanese Patent Laid-open No. 2006-350418 are known.

As technology related to logical volume capacity expansion, there is technology for dynamically expanding capacity (for example, the technology called Thin Provisioning). This type of technology, for example, is as follows.

A virtual volume, which is a virtual logical volume, is provided to a computer. The virtual volume is constituted from a plurality of virtual storage areas (referred to as “virtual areas” hereinafter).

A plurality of logical volumes is created on the basis of the storage space of a plurality of nonvolatile physical storage devices (for example, hard disk drives or flash memory drives). A cluster of one or more logical volumes from among the plurality of logical volumes is treated as a capacity pool. The capacity pool has a plurality of real areas. Hereinafter, a logical volume, which makes up the capacity pool, will be referred to as a “pool volume”. The real areas are the respective storage areas in the pool volume.

When a write request specifying a certain virtual area of the virtual volume is received from a computer, the storage system selects an unallocated real area from the plurality of real areas in the capacity pool, and allocates the selected real area to the specified virtual area. Then, the storage system writes the write-targeted data conforming to this write request to the allocated real area.

In the above-described technology, for example, mapping information denoting which real area corresponds to which virtual area is stored in a volatile memory inside the storage system. A real area is allocated to a virtual area by the mapping information being updated to information denoting the allocation of the above-mentioned selected real area to the write request-specified virtual area.

When this mapping information is volatilized from the volatile memory by reason of the power being shut off, the storage system loses track of which real areas have been allocated to which virtual areas. For this reason, for example, the storage system becomes unable to provide the correct data to a computer when it receives a read request specifying a certain virtual area in the virtual volume from the computer.

### SUMMARY

Therefore, an object of the present invention is to make it possible to restore volatilized mapping information.

Other objects of the present invention should become clear from the following explanation.

Either all or a part of the mapping information stored in the volatile memory is written to a nonvolatile storage area. When the target of a write to the nonvolatile storage area is a portion of the mapping information, as the portion of the mapping information, an information element required to restore the mapping information is written to the nonvolatile storage area from among a plurality of information elements, which make up the mapping information. The nonvolatile storage area can be provided in a nonvolatile physical storage device, which constitutes the basis of a logical volume, and can also be provided in a different nonvolatile storage device.

### BRIEF DESCRIPTION OF THE DRAWINGS

FIG. 1 shows the constitution of a computer system related to one embodiment of the present invention;

FIG. 2 shows a method for allocating a real page to a virtual page;

FIG. 3 shows mapping management information, which is one type of management information stored in the shared memory;

FIG. 4 shows an overview of a backup process;

FIG. 5 shows an overview of a restore process;

FIG. 6 shows the constitution of thinned mapping management information, which is stored in a reserved area;

FIG. 7 shows the constitution of thinned pool information;

FIG. 8 shows the constitution of a thinned virtual volume;

FIG. 9 shows the constitution of mapping information;

FIG. 10 shows the constitution of an association table and the relationship between the association table and mapping information;

FIG. 11 is a flowchart of a backup process;

FIG. 12A shows a CHA, in which an old control program is stored;

FIG. 12B shows a CHA, in which a new control program is stored;

FIG. 13 is a flowchart of the processing carried out in Step 104 of FIG. 11;

FIG. 14 is a flowchart of the processing carried out when a real page is newly allocated to a virtual page;

FIG. 15 is a flowchart of a restore process;

FIG. 16 shows the first part of a flowchart of processing (processing for one certain capacity pool 143) carried out in Step 155 of FIG. 15;

FIG. 17 shows the second part of the flowchart of processing (processing for one certain capacity pool 143) carried out in Step 155 of FIG. 15;

FIG. 18 shows the association table and mapping information at the end of Step 158 of FIG. 16; and

FIG. 19 shows the association table and mapping information at the end of Step 167 of FIG. 17.

### DESCRIPTION OF THE PREFERRED EMBODIMENT

A first embodiment comprises a storage system, which provides a virtual volume constituted from a plurality of virtual areas; a plurality of nonvolatile physical storage devices; a plurality of real areas, which constitute a capacity pool created on the basis of storage areas of the above-mentioned plurality of physical storage devices; a volatile memory for storing mapping information denoting which real area corresponds to which virtual area; an input/output controller; and a backup unit. The input/output controller, upon receiving a write request from a computer, updates the above-mentioned mapping information to information denoting that a real area selected from one or more unallocated real areas has been allocated to the virtual area specified in the above-mentioned write request, and writes data conforming to the above-mentioned write request to the allocated real area. The backup unit writes either all or part of the above-mentioned mapping information stored in the above-mentioned volatile memory to a nonvolatile storage area.

A second embodiment according to the first embodiment further comprises a restore unit. The restore unit restores the above-mentioned mapping information using a portion of the above-mentioned mapping information, which is stored in the above-mentioned nonvolatile storage area. The above-mentioned backup unit writes the information element required to restore the above-mentioned mapping information to the above-mentioned nonvolatile storage area as the portion of the above-mentioned mapping information.

In a third embodiment according to the second embodiment, the above-mentioned mapping information comprises a real-area information element denoting a real area, and a virtual-area information element denoting the allocation-target virtual area of this real area for each real area. The above-mentioned backup unit writes the above-mentioned plurality of virtual-area information elements, of the above-mentioned plurality of real-area information elements and plurality of virtual-area information elements, to the above-mentioned nonvolatile storage area.

In a fourth embodiment according to the third embodiment, the above-mentioned restore unit restores the above-mentioned mapping information to the above-mentioned volatile memory by executing processes (1) through (4) below:

(1) A process for creating in the above-mentioned volatile memory the respective entry areas, which store the respective real-area information elements corresponding to the respective real areas;

(2) a process for reading the above-mentioned plurality of virtual-area information elements from the above-mentioned nonvolatile storage area;

(3) a process for specifying which real areas are allocated to the respective virtual areas corresponding to the respective virtual-area information elements, based on the order of the respective virtual-area information elements in above-mentioned read plurality of virtual-area information elements; and

(4) a process for writing to the entry area corresponding to the specified real area a virtual-area information element denoting the allocation-target virtual area of this real area.

In a fifth embodiment according to the third embodiment, there is a plurality of the above-mentioned capacity pools. The above-mentioned respective capacity pools have a reserved area, which is a pre-reserved storage area that differ from the above-mentioned plurality of real areas. The above-mentioned reserved area is treated as the above-mentioned nonvolatile storage area. The above-mentioned mapping information is made up of sub-mapping information, which corresponds to the respective capacity pools. The above-mentioned sub-mapping information comprises a real-area information element denoting a real area, and a virtual-area information element denoting the allocation-target virtual area of this real area, for each real area making up the capacity pool corresponding to this sub-mapping information. The above-mentioned backup unit writes the above-mentioned plurality of virtual-area information elements, of the plurality of real-area information elements and plurality of virtual-area information elements, which constitute the above-mentioned sub-mapping information, to the above-mentioned reserved area in the capacity pool corresponding to this sub-mapping information.

In a sixth embodiment according to the fifth embodiment, the above-mentioned restore unit restores the sub-mapping information for the respective capacity pools in the above-mentioned volatile memory by executing processes (1) through (4) below for each capacity pool:

(1) a process for creating in the above-mentioned volatile memory the respective entry areas, which store the respective real-area information elements corresponding to the respective real areas, which constitute the capacity pool;

(2) a process for reading the above-mentioned plurality of virtual-area information elements from the above-mentioned reserved area;

(3) a process for specifying which real areas in the capacity pool are allocated to the respective virtual areas corresponding to the respective virtual-area information elements, based on the order of the respective virtual-area information elements in the above-mentioned read plurality of virtual-area information elements; and

(4) a process for writing to the entry area corresponding to the specified real area a virtual-area information element denoting the allocation-target virtual area of this real area.

In a seventh embodiment according to any of the third through the sixth embodiments, the above-mentioned capacity pool is constituted from one or more pool volumes, which are one or more logical volumes of a plurality of logical volumes created on the basis of the storage areas of the above-mentioned plurality of physical storage devices. The above-mentioned volatile memory further stores pool information, which is information related to the above-mentioned capacity pool, and virtual volume information, which is information related to a virtual volume associated to the capacity pool, from among a plurality of virtual volumes. The above-mentioned pool information comprises pool volume identification information for identifying a pool volume, which constitutes the above-mentioned capacity pool. The above-mentioned virtual volume information comprises virtual volume identification information for identifying a virtual volume associated to the above-mentioned capacity pool. The above-mentioned backup unit writes the above-mentioned pool volume identification information to the above-mentioned nonvolatile storage area as a portion of the above-mentioned pool information, and writes the above-mentioned virtual volume identification information to the above-mentioned nonvolatile storage area as a portion of the above-mentioned virtual volume information.

In an eighth embodiment according to the seventh embodiment, the above-mentioned backup unit writes pool volume identification information for identifying a pool volume, which constitutes this capacity pool, to the above-mentioned nonvolatile storage area when a new capacity pool is created.

In a ninth embodiment according to either the seventh or eighth embodiment, when a new virtual volume is associated with the above-mentioned capacity pool, the above-mentioned backup unit adds the virtual volume identification information of the newly associated virtual volume to the above-mentioned nonvolatile storage area.

In a tenth embodiment according to any of the seventh through the ninth embodiments, when the association of a virtual volume with the above-mentioned capacity pool is deleted, the above-mentioned backup unit nullifies the virtual volume identification information of the virtual volume for which the association was deleted and the virtual-area information element denoting the virtual area that constitutes this virtual volume, which are stored in the above-mentioned nonvolatile storage area.

In an eleventh embodiment according to any of the seventh through the tenth embodiments, when the status related to the above-mentioned capacity pool changes, the above-mentioned backup unit writes the post-change status to the above-mentioned nonvolatile storage area as a portion of the above-mentioned pool information.

In a twelfth embodiment according to any of the seventh through the eleventh embodiments, the above-mentioned restore unit restores the above-mentioned mapping information in the above-mentioned volatile memory by executing the processes (1) through (6) below:

(1) a process for reading the above-mentioned pool volume identification information from the above-mentioned nonvolatile storage area, and, based on the above-mentioned pool volume identification information, creating in the above-mentioned volatile memory a pool directory, which is a storage area corresponding to the pool volume, and the respective entry areas, which store the respective real-area information elements corresponding to the respective real areas constituting this pool volume;

(2) a process for reading the above-mentioned virtual volume identification information from the above-mentioned nonvolatile storage area, and, based on the above-mentioned virtual volume identification information, creating in the above-mentioned volatile memory a virtual volume directory, which is a storage area corresponding to the virtual volume;

(3) a process for reading the above-mentioned plurality of virtual-area information elements from the above-mentioned nonvolatile storage area;

(4) a process for specifying which real areas in the capacity pool are allocated to the respective virtual areas corresponding to the respective virtual-area information elements, based on the order of the respective virtual-area information elements in the above-mentioned read plurality of virtual-area information elements;

(5) a process for writing to the entry area corresponding to the specified real area a virtual-area information element denoting the allocation-target virtual area of this real area; and

(6) a process for writing the address of the entry area corresponding to the specified real area to a sub-directory, which is specified from the virtual-area information element denoting the allocation-target virtual area of this real area, in the above-mentioned virtual volume directory.

In a thirteenth embodiment according to any of the third through the twelfth embodiments, when, in accordance with a real area being allocated to a virtual area for which a real area is not allocated, the virtual-area information element, which denotes the allocation-target virtual area in the real-area information element denoting the allocated real area, is written to the above-mentioned mapping information, the above-mentioned backup unit writes the written virtual-area information element to the above-mentioned nonvolatile storage area.

A fourteenth embodiment, according to any of the third through the thirteenth embodiments, further comprises a cache area for temporarily storing data, which has been written to each of the above-mentioned plurality of physical storage devices. The above-mentioned nonvolatile storage area is the storage area of one or more physical storage devices of the above-mentioned plurality of physical storage devices. The above-mentioned backup unit writes to the above-mentioned cache area a group of information elements of information transfer unit size, comprising a virtual-area information element, which has been written to the above-mentioned mapping information, and writes the above-mentioned group of information elements from the above-mentioned cache area to the above-mentioned nonvolatile storage area, which is the storage area of the above-mentioned one or more physical storage devices.

A fifteenth embodiment, according to any of the third through the fourteenth embodiments, further comprises a microprocessor. If a computer program comprising the above-mentioned backup unit is installed as the computer program to be executed by the above-mentioned microprocessor, the above-mentioned microprocessor executes the installed computer program so as to write the respective virtual-area information elements stored in the above-mentioned volatile memory to the above-mentioned nonvolatile storage area.

In a sixteenth embodiment according to any of the second through the fifteenth embodiments, the above-mentioned restore unit executes a restore without receiving an indication from the user when power is being supplied to the above-mentioned volatile memory from a primary power source.

In a seventeenth embodiment according to any of the second through the sixteenth embodiments, the above-mentioned restore unit executes a restore upon receiving an indication from the user when power is not being supplied to the above-mentioned volatile memory from the primary power source.

In an eighteenth embodiment according to any of the second through the seventeenth embodiments, the above-mentioned backup unit transfers a portion of the above-mentioned backup information to the above-mentioned nonvolatile storage area, as well as to an information processing device comprising a nonvolatile storage device. When a portion of the above-mentioned mapping information has been successfully read from the above-mentioned information processing device, the above-mentioned restore unit restores the above-mentioned mapping information on the basis of this portion of the mapping information. When a portion of the above-mentioned mapping information has failed to be read from the above-mentioned information processing device, the above-mentioned restore unit reads the portion of the above-mentioned mapping information from the above-mentioned nonvolatile storage area.

In a nineteenth embodiment, a virtualization system, which provides a virtual volume, comprises the above-mentioned volatile memory; the above-mentioned input/output controller; and the above-mentioned backup controller. At least one of the above-mentioned volatile memory, the above-mentioned input/output controller, and the above-mentioned backup controller can be made an element in any of the second through the eighteenth embodiments. Further, the virtualization system can also comprise a restore unit in any of the second through the eighteenth embodiments. The virtualization system can also comprise the above-mentioned cache area.

A twentieth embodiment is a method for realizing a system comprising a function for providing a virtual volume, which is constituted from a plurality of virtual areas; and a volatile memory for storing the above-mentioned mapping information. In this method, when a write request is received from the computer, the above-mentioned mapping information is updated to information denoting the allocation of a real area, which was selected from one or more unallocated real areas, to the virtual area specified in the above-mentioned write request, data conforming to the above-mentioned write request is written to the allocated real area, and either all or part of the above-mentioned mapping information stored in the above-mentioned volatile memory is written to a nonvolatile storage area. Either all or part of the mapping information stored in the nonvolatile storage area can be read, and the above-mentioned mapping information can be restored to the above-mentioned volatile memory based on the read information.

The respective units (input/output unit, backup unit, restore unit) can be constructed from hardware, a computer program, or a combination of the two (for example, a portion of these units being realized via a computer program, and the remainder being realized via hardware). The computer program is executed by being read into a prescribed processor. Further, when information processing is carried out by the computer program being written to the processor, a storage region residing in memory or some other such hardware resource can also be utilized. Further, the computer program can be either installed in the computer from a CD-ROM or other such recording medium, or this computer program can be downloaded to the computer via a communication network.

An embodiment of the present invention will be explained in detailed hereinbelow by referring to the figures.

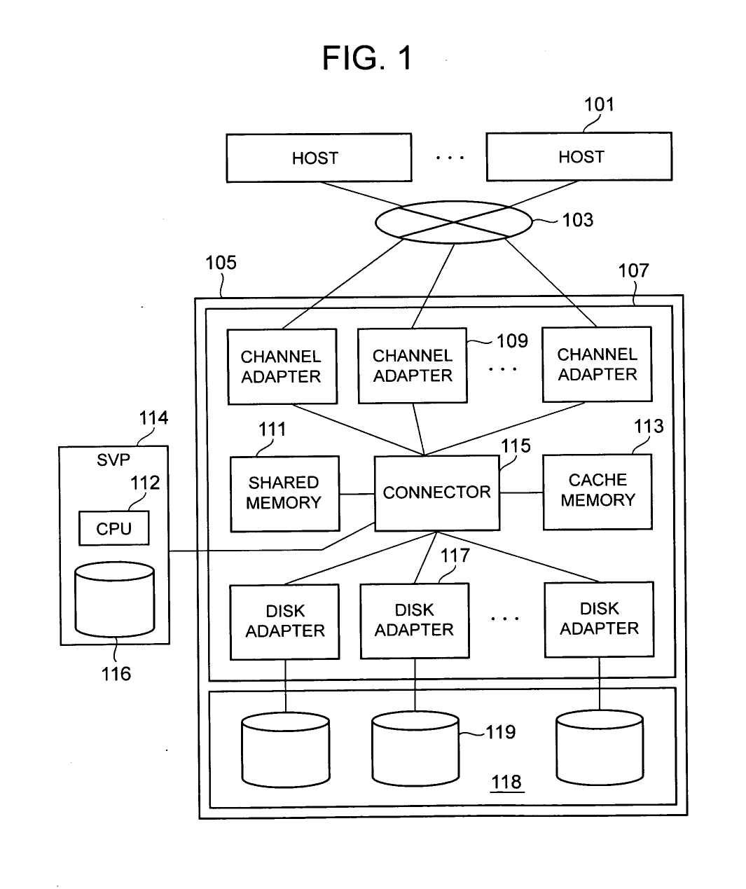

FIG. 1 shows the constitution of the computer system related to an embodiment of the present invention.

One or a plurality of host computers 101, and a storage system 105 are connected to a communication network (for example, a SAN) 103.

The host computer 101, for example, is a computer device comprising a CPU (Central Processing Unit), a memory and other such information processing resources, and, for example, is constituted as a personal computer, workstation, mainframe, or the like.

The storage system 105, for example, can be a RAID system comprising a large number of physical storage devices 119 arranged in an array. However, the present invention is not limited to this, and the storage system 105 can also be constituted as a high-functionality intelligent fibre channel switch. The storage system 105 can be broadly divided into a controller 107, and a storage unit 118.

The controller 107, for example, comprises a channel adapter (CHA) 109, a disk adapter (DKA) 117, a cache memory 113, a shared memory 111, and a connector 115.

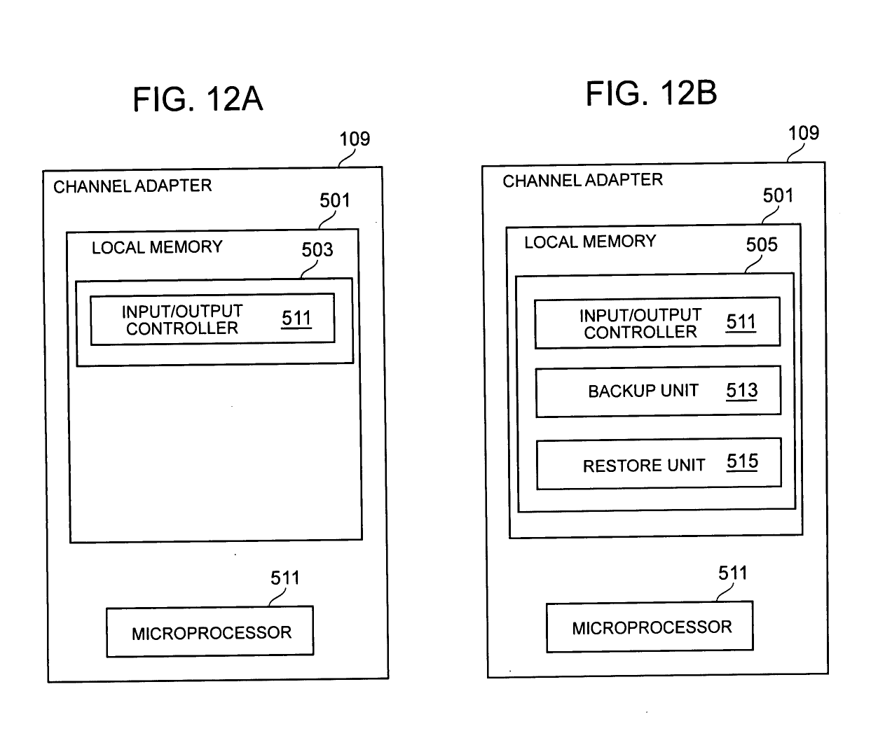

The CHA 109 is an interface device for carrying out data communications with the host computer 101 or other storage system. The CHA 109, for example, can be constituted as a device (for example, a circuit board) comprising a microprocessor 511, and a memory (referred to as “local memory” hereinafter) 511, as shown in FIG. 12B. For example, the CHA 109 can receive a write request from the host computer 101, and write the data conforming to the received write request to the cache memory 113 by commanding the DKA 117 to write this data. Further, for example, the CHA 109 can receive a read request from the host computer 101, command the DKA 117 to read data conforming to the received read request, read data conforming to this command from the cache memory 113, and send this data to the host computer 101.

Furthermore, computer programs (referred to as “control programs” hereinafter) 505, which are executed by the microprocessor 511, are stored in the local memory 501 of the CHA 109, as shown in FIG. 12B. These control programs 505 are the input/output controller 511, the backup unit 513, and the restore unit 515. The input/output controller 511 is a module for executing the processing of an I/O request (write request/read request) from the host computer 101. The backup unit 513 is a module for executing a backup process for backing up a portion of the mapping management information, which will be explained hereinbelow. The restore unit 515 is a module for executing a restore process for restoring the mapping management information, based on the portion of the mapping management information, which has been backed up. In this embodiment, as will be explained below, a backup process is executed in response to updating an old control program 503 (refer to FIG. 12A) to a new control program 505. The input/output controller 511, backup unit 513 and restore unit 515 can also be realized via hardware by making the processors for carrying out the respective processes integrated circuits. In the following explanation, when a computer program is the subject, it is supposed that processing will be carried out by the microprocessor, which actually executes this computer program. Furthermore, when the respective processors are realized using hardware, these respective processors will become the main units for carrying out the respective processing.

The DKA 117 is an interface device for carrying out data communications with a physical storage device 119. The DKA 117 can also be constituted as a device (for example, a circuit board) comprising a microprocessor and a memory (local memory). For example, the DKA 117 can write data stored in the cache memory 113 to the physical storage device 119 in response to a write command from the CHA 109. Also, for example, the DKA 117, in response to a read command from the CHA 109, can read data conforming to this command from the physical storage device 119, and can write this data to the cache memory 113.

The cache memory 113 temporarily stores data received from the host computer 101, and data read from the physical storage device 119.

The shared memory 111 is the volatile memory, and stores information, which is referenced by the CHA 109 or DKA 117 for controlling to storage system 105 (referred to as “management information” hereinafter). The types of management information will be explained in detail hereinbelow.

The connector 115 interconnects the CHA 109, DKA 117, cache memory 113, and shared memory 111. The connector 115, for example, can be constituted as a highspeed bus, such as an ultra-highspeed crossbar switch or the like, which carries out data transmission by virtue of a highspeed switching operation.

The storage unit 118 comprises a plurality of physical storage devices 119. As the physical storage device 119, for example, a hard disk drive, flexible disk drive, magnetic tape drive, semiconductor memory drive, optical disk drive or other such device can be used. A RAID Group of a prescribed RAID level can be constituted using no less than two physical storage devices 119. The storage space of the no less than two physical storage devices 119 constituting the RAID Group can be used to form a substantial logical volume (referred to as a “real VOL” hereinafter). Either one or a cluster of a plurality of real VOL can constitute a capacity pool, which comprises a plurality of real areas allocated to a virtual volume (referred to as a “virtual VOL” hereinafter). The real VOL, which constitutes the capacity pool, will be referred to as the “pool VOL” hereinafter. One storage area (that is, a real area) in the pool VOL is allocated to the virtual VOL provided to the host computer 101.

The storage system 105 further comprises a service processor (abbreviated as “SVP” hereinafter) 114 as a computer for carrying out the maintenance and/or management of the storage system 105. The SVP 114, for example, comprises a CPU 112, and a nonvolatile storage device (for example, a hard disk drive) 116. The CPU 112 writes information received from the storage system 105 to the nonvolatile storage device 116.

The preceding is an explanation regarding the constitution of the computer system related to this embodiment. Furthermore, this constitution is an example, and the constitution of the storage system is not limited to the constitution of FIG. 1. A different constitution can be employed. For example, the shared memory 111 and cache memory 113 do not have to be separate memories, and a shared memory area and cache memory area can be provided in a single volatile memory. Also, for example, the controller 107 can be a circuit board comprising a CPU, volatile memory, and a plurality of communication ports (that is, a simpler constitution that the controller of FIG. 1). In this case, this CPU can execute the processing carried out by the plurality of CHA and DKA.

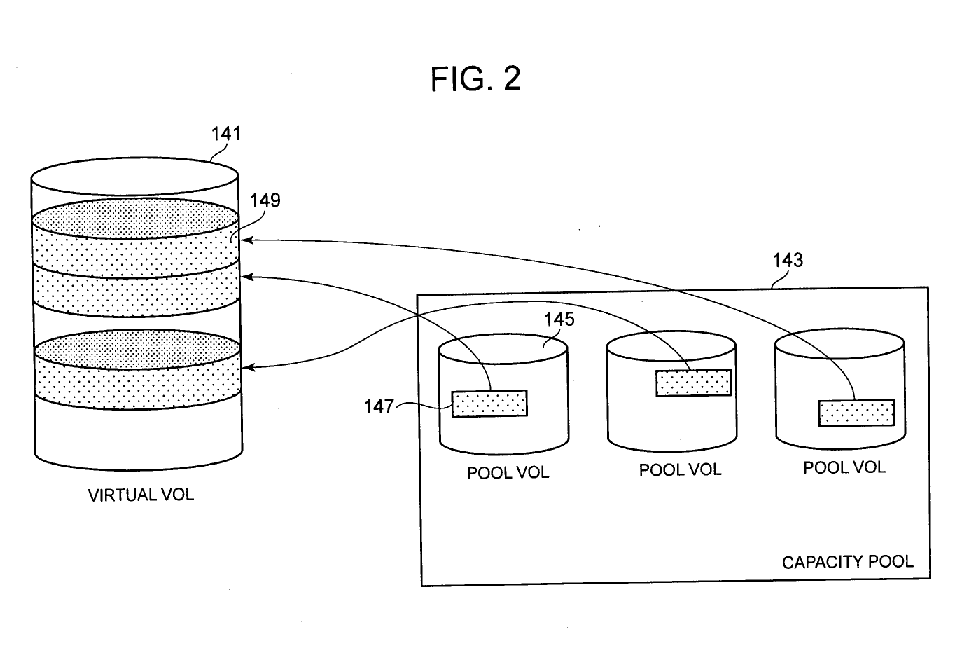

As a method for allocating a real area to the virtual VOL, a method, which will be explained by referring to FIG. 2, can be used.

When the CHA 109 receives a write request specifying a virtual area 149 of a virtual VOL 141 from the host computer 101, the input/output controller 511 selects an unallocated real area 147 from a plurality of pool VOL 145 belonging to a capacity pool 143, and allocates the selected real area 147 to the above-mentioned specified virtual area 149. Then, the input/output controller 511 writes data conforming to the above-mentioned received write request to the allocated real area 147. In the following explanation, the area, which constitutes the allocation unit, will be called a “page” for convenience sake. More specifically, the real area (one storage area in the pool VOL), which is the allocation-source, will be called a “real page”, and the virtual area (one storage area of the virtual VOL), which is the allocation-target, will be called a “virtual page”. The real page and virtual page are both the same size, and one real page is allocated to one virtual page.

The updating of the mapping information, which denotes which real page is allocated to which virtual page, to information denoting that a certain real page has been allocated to a certain virtual page by the input/output controller 511 constitutes the allocation of the certain real page to the certain virtual page. The mapping information is stored in the shared memory 111 (The mapping information is one of the information elements constituting the management information.). Consequently, any of the plurality of CHA 109 can allocate a real page to a virtual page, that is, can carry out the dynamic expansion of the actual storage capacity of the virtual VOL.

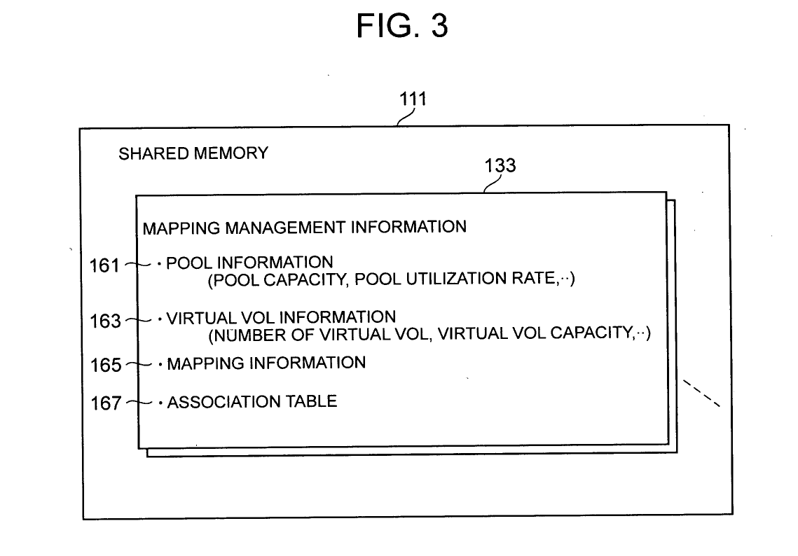

FIG. 3 shows mapping management information, which is one type of management information stored in the shared memory 111.

Mapping management information 133 exists in each capacity pool 143. Mapping management information 133 is information for managing the mapping of the real page in the capacity pool 143, which corresponds to the mapping management information 133 (hereinafter, mapping capacity pool 143), to the virtual page in the virtual volume, which is associated to the mapping capacity pool 143. The mapping management information 133, for example, comprises pool information 161, virtual VOL information 163, mapping information 165, and an association table 167.

Pool information 161 is information related to the mapping capacity pool 143. More specifically, for example, pool information 161 comprise the pool capacity (the storage capacity of the mapping capacity pool 143); pool utilization rate (a percentage denoting the number of real pages, from among all the real pages in the mapping capacity pool 143, allocated to the virtual VOL); and number of pool VOL (number of pool VOL constituting the mapping capacity pool 143).

Virtual VOL information 163 is information related to the virtual VOL associated to the mapping capacity pool 143. More specifically, for example, the virtual VOL information 163 comprises the number of virtual VOL (the number of virtual VOL associated to the mapping capacity pool 143). Further, as information elements corresponding to each virtual VOL associated to the mapping capacity pool 143, virtual VOL information 163, for example, comprises the virtual VOL capacity (the storage capacity of the virtual VOL); and the virtual VOL utilization rate (a percentage denoting the number of virtual pages, from among all the virtual pages constituting the virtual VOL, to which real pages are allocated).

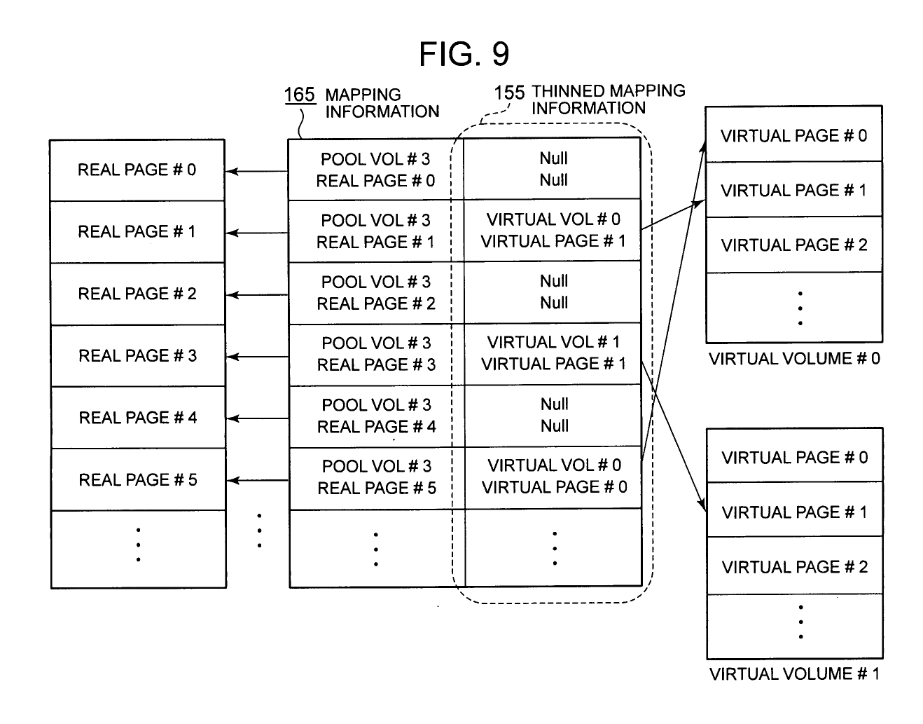

The mapping information 165 denotes the corresponding relationship between a real page and a virtual page in the mapping capacity pool 143. The constitution of the mapping information 165 will be explained below by referring to FIG. 9.

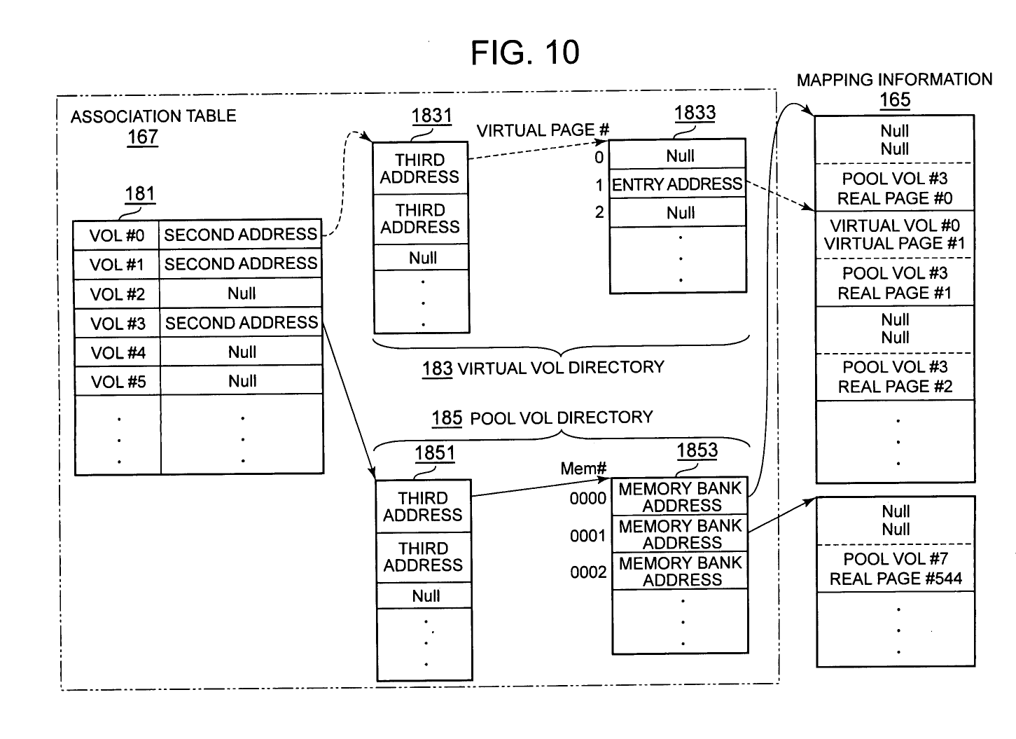

The association table 167 is for associating the virtual VOL 141 and pool VOL 145 to the mapping information 165. The constitution of the association table 167 will be explained below by referring to FIG. 10.

In this embodiment, the backup unit 513 backs up a portion of the above-described mapping management information 133 in the nonvolatile storage area. Then, the restore unit 515 reads the portion of the mapping management information 133, which is stored in the nonvolatile storage area, and uses this portion of the mapping management information 133 to restore the mapping management information 133 in the shared memory 111.

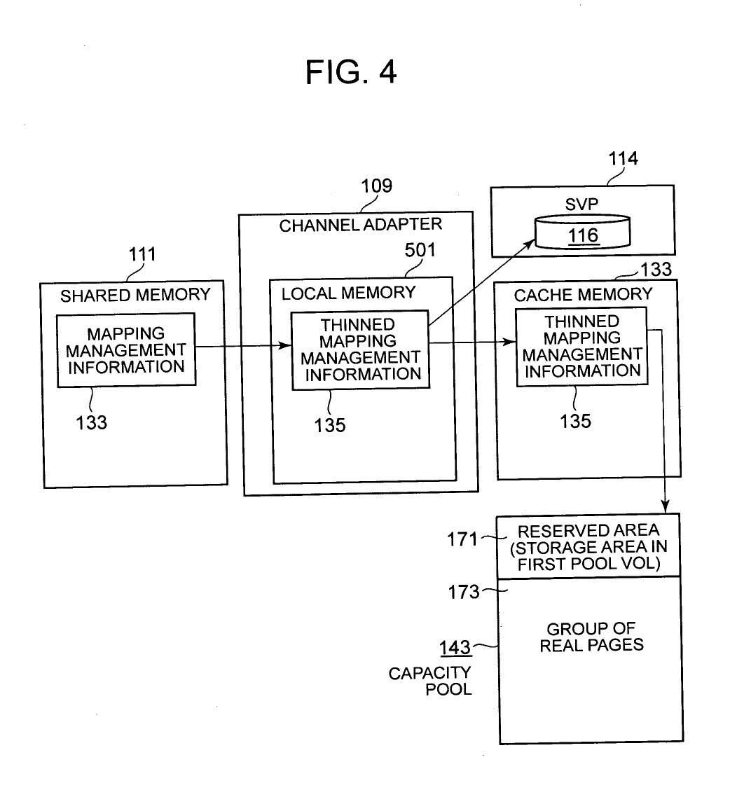

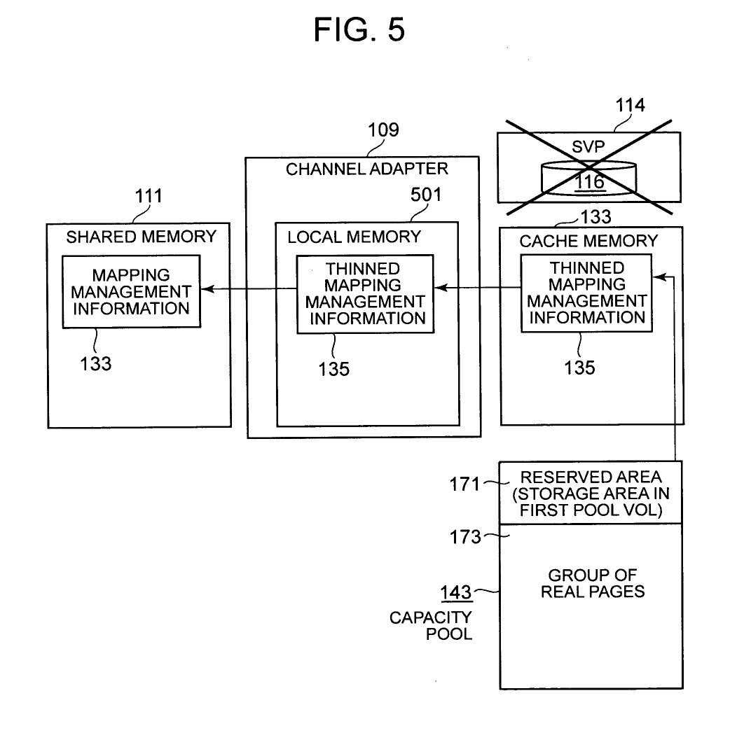

FIG. 4 shows an overview of a backup process. A plurality of capacity pools 143 can be provided in the storage system 105, but to make the explanation easier to understand, one capacity pool 143 is shown in FIG. 4 (and in the subsequently explained FIG. 5).

A storage area 171 of a prescribed size is reserved in advance in the capacity pool 143. Hereinafter, this pre-reserved storage area will be referred to as the “reserved area”. Thus, the storage area of the capacity pool 143 can be broadly divided into the reserved area 171, and a group of real pages 173, which is constituted from a plurality of real pages capable of being allocated to the virtual VOL. A storage area for use in a different application can be provided in the capacity pool 143 in addition to the reserved area 171 and group of real pages 173.

The reserved area 171 constitutes a nonvolatile storage area of a portion of the backup-destination of the mapping management information 133 corresponding to the capacity pool 143 of this reserved area 171. The reserved area 171, for example, is provided in the first pool VOL (VOL with the lowest VOL #) of the plurality of pool VOL that make up the capacity pool 143.

The backup unit 513 backs up a portion of the mapping management information 133 in the reserved area 171 of the mapping capacity pool 143 without backing up all of the mapping management information 133 stored in the shared memory 111. The portion of the mapping management information 133 is information constituting the information elements remaining in the mapping management information 133 from which information elements not essential for restoring the mapping management information 133 have been culled. Hereinafter, this information will be referred to as “thinned mapping management information”.

The backup unit 513 selects information elements essential to a restore from the mapping management information 133 stored in the shared memory 111, and writes the respective selected information elements to the local memory 501. By so doing, thinned mapping management information 135 is created in the local memory 501.

The backup unit 513 transfers the thinned mapping management information 135 stored in the local memory 501 to the SVP 114. The CPU 112 of the SVP 114 writes the thinned mapping management information 135 received from the backup unit 513 to the nonvolatile storage device 116.

Further, the backup unit 513 transfers the thinned mapping management information 135 stored in the local memory 501 to the cache memory 113. By so doing, the thinned mapping management information 135 is stored in the cache memory 113. The thinned mapping management information 135 stored in the cache memory 113 is written to the reserved area 171 in the mapping capacity pool 143 by a destage job executed by the input/output controller 511.

The restore unit 515 can read the thinned mapping management information 135 from both the SVP 114 and the reserved area 171. In this embodiment, the restore unit 515 can read the thinned mapping management information 135 from the SVP 114 more quickly than from the reserved area 171. Thus, the restore unit 515, in principal, reads the thinned mapping management information 135 from the SVP 114, and uses this thinned mapping management information 135 to restore the mapping management information 133. However, when a read of the thinned mapping management information 135 from the SVP 114 fails due to the failure of the SVP 114, the restore unit 515 reads the thinned mapping management information 135 from the reserved area 171 in the mapping capacity pool 143.

FIG. 5 shows an overview of a restore process.

As described hereinabove, when a read of the thinned mapping management information 135 from the SVP 114 fails, the restore unit 515 reads the thinned mapping management information 135 from the reserved area 171 in the mapping capacity pool 143 (More specifically, the restore unit 515 has the DKA 117 read the thinned mapping management information 135 to the cache memory 113 from the reserved area 171.). The restore unit 515 writes the read thinned mapping management information 135 to the local memory 501. Then, the restore unit 515 uses this thinned mapping management information 135 to restore the mapping management information 133 corresponding to the mapping capacity pool 143 in the shared memory 111.

The preceding overviews are of a backup process and a restore process. Furthermore, the thinned mapping management information 135 does not necessarily have to be written to the nonvolatile storage device 116 of the SVP 114. For example, there is a double backup mode, which stores the thinned mapping management information 135 in both the SVP 114 nonvolatile storage device 116 and the reserved area 171, and a single backup mode, which stores the thinned mapping management information 135 only in the reserved area 171, and the user can select either mode.

According to the above explanation, the mapping management information 133 itself is not backed up, but rather, an information element required to restore the mapping management information 133 is selected, and thinned mapping management information 135 comprising this information element is backed up. In the mapping management information 133, an information element that is not backed up is computed on the basis of the information element comprised in the thinned mapping management information 135. Thus, the mapping management information 133 is properly culled and backed up, thereby making it possible to conserve consumed storage capacity.

Further, according to the above explanation, a reserved area 171 is provided in advance for each capacity pool 143, and the thinned mapping management information 135 is written to this reserved area 171. Consequently, the reserved area 171 can be utilized effectively without becoming a dead space. Even if the size of the reserved area 171 is smaller than that of the mapping management information 133, since the backup target is not the mapping management information 133 itself, but rather the thinned mapping management information 135 created by culling out the information element from the mapping management information 133 not necessary for the restoration thereof (for example, an information element capable of being computed from another information element), a backup to the reserved area 171 becomes possible.

The constitution of the thinned mapping management information 135 will be explained in detail below.

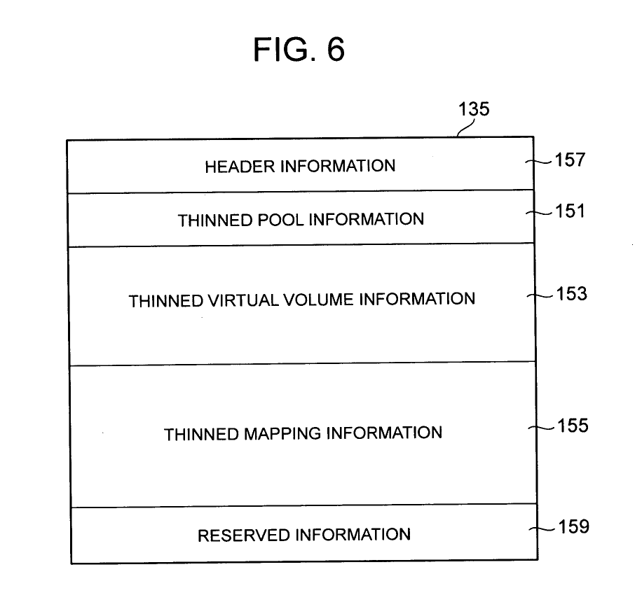

FIG. 6 shows the constitution of the thinned mapping management information 135 stored in the reserved area 171.

Thinned mapping management information 135 is constituted from header information 157, thinned pool information 151, a thinned virtual VOL 153, thinned mapping information 155, and reserved information 159. At least one of these pieces of information 157, 151, 153, 155, 159 can be multiplexed (for example, duplexed) and stored.

The header information 157 is for managing the reserved area 171. The header information 157 can comprise an information element for uniquely specifying the format of the thinned mapping information 155.

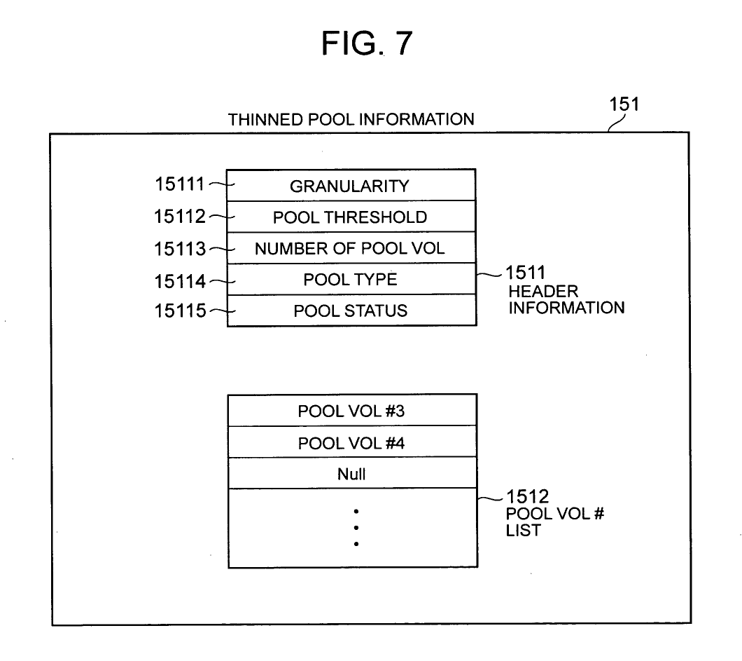

FIG. 7 shows the constitution of thinned pool information 151.

Thinned pool information 151 is information derived by culling an information element not needed to restore the pool information 161 from the pool information 161. Thinned pool information 151 comprises header information 1511, and a pool VOL # list 1512.

The header information 1511, for example, comprises granularity 15111, a pool threshold 15112, the number of pool VOL 15113, the pool type 15114, and the pool status 15115. Granularity 15111 is an information element denoting the size of one real page. The pool threshold 15112 is an information element denoting the percentage of free space in the capacity pool 143 (100—pool utilization rate (%)) below which a warning is issued. The number of pool VOL 15113 is an information element denoting the number of pool VOL constituting the capacity pool 143. The pool type 15114 is an information element denoting the type of the capacity pool 143 (for example, a capacity pool 143 for a virtual VOL, snapshot, and so forth). The pool status 15115 is an information element denoting the status of the capacity pool 143 (for example, normal, blocked, and so forth).

The pool VOL # of the respective pool VOL 145 constituting the capacity pool 143 are recorded in the pool VOL # list 1512. Furthermore, the pool VOL # list 1512 can be information of a prescribed size, having storage areas amounting to the maximum number of pool VOL 145 constituting one capacity pool 143. When the number of pool VOL 145 constituting the capacity pool 143 does not satisfy the maximum number of pool VOL 145, invalid data (for example, null data) is recorded in the pool VOL # list 1512. The number of invalid data that can be recorded is the difference between the maximum number of pool VOL 145 and the number of pool VOL 145.

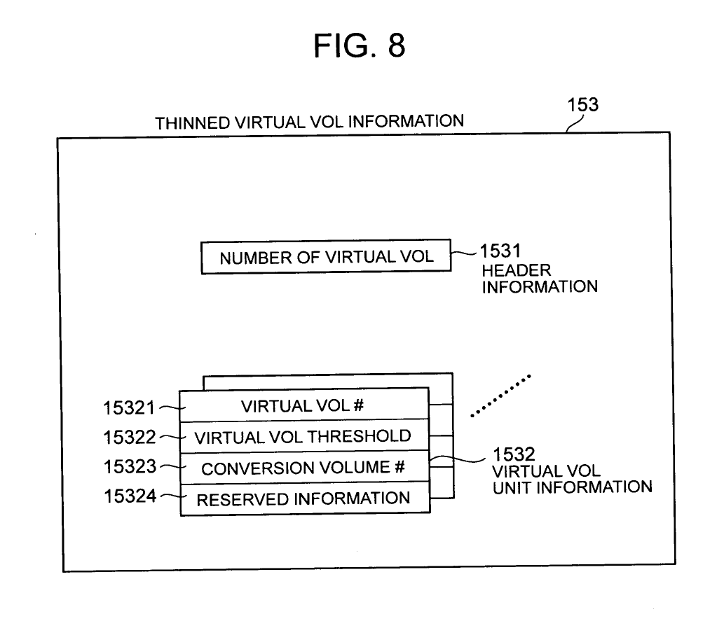

FIG. 8 shows the constitution of a thinned virtual VOL 153.

The thinned virtual VOL 153 is information derived by culling from the virtual VOL 163 an information element not needed to restore the virtual VOL 163. The thinned virtual VOL 153 comprises header information 1531, and virtual VOL unit information 1532.

The header information 1531, for example, comprises an information element denoting the number of virtual VOL 141 associated to the mapping capacity pool 143.

Virtual VOL unit information 1532 exists in each virtual VOL 141 associated to the mapping capacity pool 143. Virtual VOL unit information 1532, for example, comprises virtual VOL # 15321, virtual VOL threshold 15322, conversion volume # 15323, and reserved information 15324. The virtual VOL # 15321 is an information element denoting the virtual VOL # of the virtual VOL 141 corresponding to the virtual VOL unit information 1532 (referred to as “correspondent virtual VOL” hereinafter). The virtual VOL threshold 15322 is an information element denoting the value of the free capacity in a correspondent virtual VOL 141-associated capacity pool 143, relative to the free capacity of the correspondent virtual VOL 141, below which a warning is issued (For example, when the virtual VOL threshold is configured at 300%, a warning is issued when the free capacity of the capacity pool 143 is less than three times the free capacity of the virtual VOL.). The conversion volume # is the VOL # of the migration-destination logical volume of data stored in the correspondent virtual VOL 141 (more specifically, data stored in the real page allocated to the correspondent virtual VOL 141).

FIG. 9 shows the constitution of mapping information 165.

Mapping information 165 has, for each real page in the mapping capacity pool 143, an information element denoting a real page (referred to as a “real-page information element” hereinafter), and an information element denoting the allocation-target virtual page of this real page (referred to as a “virtual-page information element” hereinafter). The real-page information element, for example, is a combination of the pool VOL # and the real page #. The virtual-page information element, for example, is a combination of the virtual VOL # and the virtual page #. A virtual-page information element corresponding to an unallocated real page is data signifying non-allocation, for example, null data. Hereinafter, a real page may be represented by a combination of the real VOL # and the real page #. Further, a virtual page may be represented by a combination of the virtual VOL # and the virtual page #.

According to FIG. 9, it is clear that the real page [pool VOL #3, real page #0] is an unallocated real page. Further, it is clear that real page [pool VOL #3, real page #1] has been allocated to virtual page [virtual VOL #0, virtual page #1].

The mapping information 165 is constituted by K (where K is an integer of 1 or greater, for example, K=16000) entries respectively corresponding to K real pages. One entry comprises a real-page information element, which corresponds to the real page corresponding to this entry, and a virtual-page information element.

In this embodiment, the above-described thinned mapping information 155 is information derived by culling out all the real-page information elements from the mapping information 165, in other words, information in which only virtual-page information elements remain, as shown in FIG. 9. More specifically, for example, thinned mapping information 155 is constituted by virtual-page information elements, which are lined up in the ascending order of the real page #. Thus, for example, it is possible to compute which real page in the mapping capacity pool 143 is allocated to a virtual page corresponding to which virtual-page information element, based on the location (order) of this virtual-page information element in the thinned mapping information 155. For example, it is clear that the second real page in the mapping capacity pool 143 (the real page of real page #2) has been allocated to the virtual page, which corresponds to the second virtual-page information element (the information element that is not null data).

FIG. 10 shows the constitution of the association table 167, and the relationship between the association table 167 and the mapping information 165.

The association table 167 is constituted by a first sub-table 181, a pool VOL directory 185, and a virtual VOL directory 183.

A VOL # and second address are recorded in the respective records (rows) of the first sub-table 181. This VOL # is the logical volume VOL # of either the pool VOL, which constitutes the mapping capacity pool 143, or the virtual VOL associated to the mapping capacity pool 143. The second address is the address of the record (row) of either second sub-table 1831 or 1851.

The pool VOL directory 185 is a group of tables for specifying an entry corresponding to the pool VOL 145 (an entry in the mapping information 165). The pool VOL directory 185, for example, constitutes a second sub-table 1851, and a third sub-table 1853. A third address is recorded in the respective records (rows) of the second sub-table 1851. The third address is the address of a record in the third sub-table 1853. A memory bank address is recorded in the respective records (rows) of the third sub-table 1853. The memory bank address is the address of the starting entry of M entries. Furthermore, M is an integer of 1 or greater, and is a value that is smaller than the number of entries K constituting the mapping information 165 (for example, M=544).

The virtual VOL directory 183 is a group of tables for specifying an entry corresponding to a real page allocated to an arbitrary virtual page. The virtual VOL directory 183, for example, is constituted by a second sub-table 1831 and a third sub-table 1833. A third address is recorded in the respective records (rows) of the second sub-table 1831. The third address is the address of a record in the third sub-table 1833. The third sub-table 1833 exists in each virtual VOL 141 associated to the mapping capacity pool 143. The respective records (rows) of the third sub-table 1833 correspond to the respective virtual pages in the virtual VOL 141 corresponding to this third sub-table 1833. The address of an entry in the mapping information 165 is recorded in the respective records of the third sub-table 1833.

According to the association table 167 of FIG. 10, for example, with regard to VOL #3, a group of entries corresponding to the pool VOL of VOL #3 are specified by searching through the pool VOL directory 185. Further, for VOL #0, the entry corresponding to the second virtual page in the virtual VOL of VOL #0 is specified by searching through the virtual VOL directory 183. According to this entry, it is clear that the real page [pool VOL #3, real page #1] has been allocated to this virtual page.

In this embodiment, the above-described association table 167 is not backed up in the reserved area 171 of the mapping capacity pool 143. This is because the association table 167 can be restored based on the thinned pool information 151 and the thinned virtual VOL 153.

Backup processing and restore processing in this embodiment will be explained in detail hereinbelow.

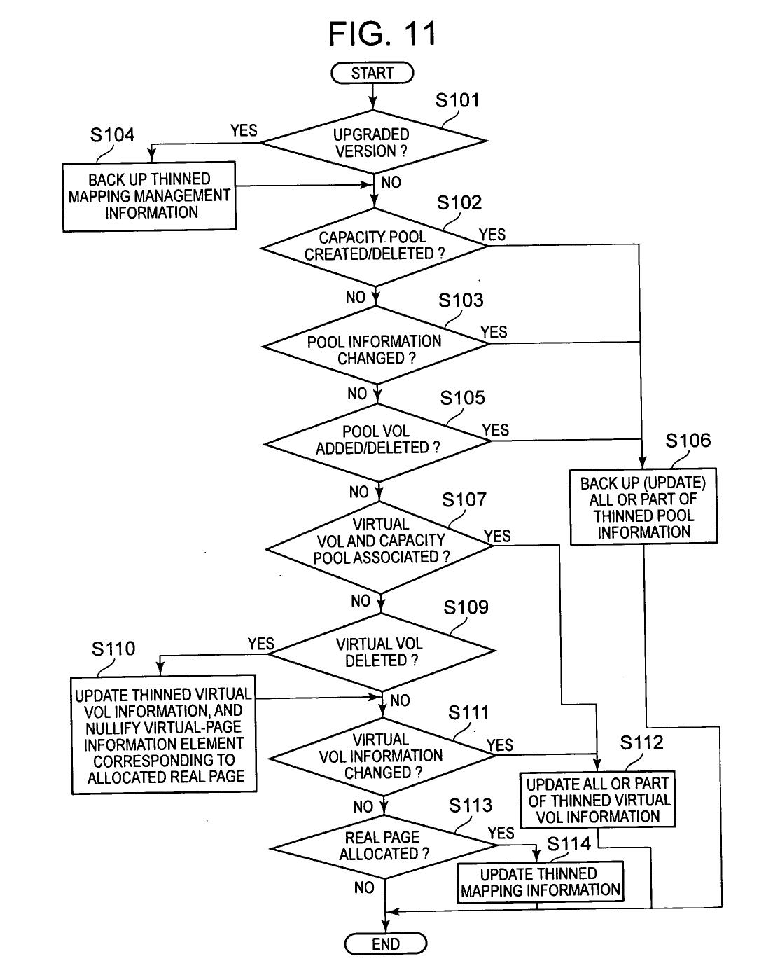

FIG. 11 is a flowchart of a backup process. Furthermore, the following explanation will take an example of backup being carried out to the reserved area 171, and an explanation of backup being carried out to the nonvolatile storage device 116 of the SVP 114 will be omitted.

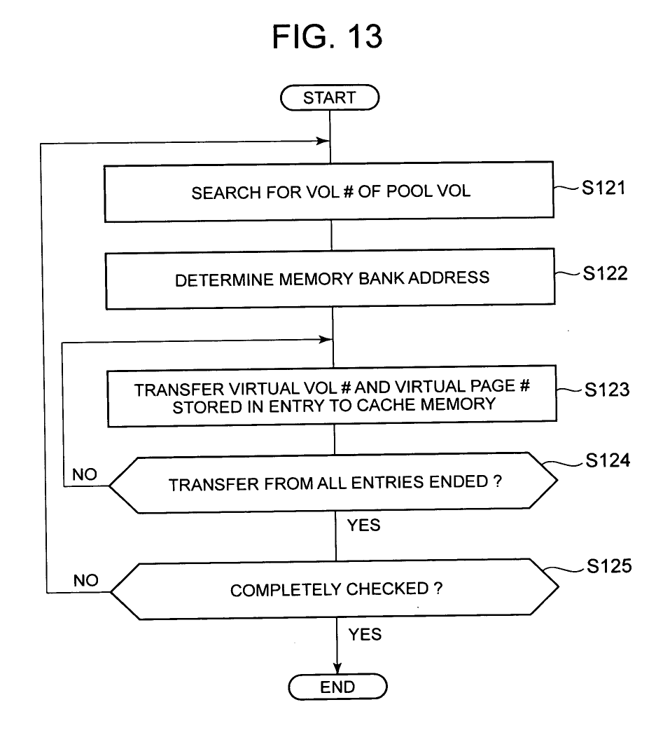

When the control program executed in the respective CHA 109 is upgraded from the old control program 503 (refer to FIG. 12A) to the new control program 505 (refer to FIG. 12B) (Step 101: YES), thinned mapping management information 135 corresponding to the respective capacity pools 143 is backed up to the reserved areas 171 of the respective capacity pools 143 by the backup unit 513 in the new control program 505 (Step 104). The processing of Step 104 will be explained in detail below by referring to FIG. 13.

When a capacity pool 143 is either created or deleted (Step 102: YES), the mapping management information 133 corresponding to this capacity pool 143 is also either created or deleted. Therefore, in this case, the backup unit 513 backs up either all or part of the thinned pool information 151 to the corresponding reserved area 171 (Step 106). More specifically, for example, when the capacity pool 143 is created, the backup unit 513 formats the reserved area 171 of the created capacity pool 143, and writes the thinned pool information 151 to the location in which the thinned pool information 151 is stored in this reserved area 171. Further, for example, when the capacity pool 143 is deleted, the backup unit 513 nullifies the thinned pool information 151 in the reserved area 171 of the deleted capacity pool 143 (for example, assigns a value of “0” to the thinned pool information 151).

When the pool information 161 changes (Step 103: YES), the backup unit 513 updates the portion corresponding to the changed portion of the pool information 161 in the thinned pool information 151 (Step 106). More specifically, for example, when the capacity pool 143 is blocked (when the pool status constitutes “blocked”), the backup unit 513 updates the pool status 15115 in the thinned pool information 151 stored in the reserved area 171 to “blocked”. Further, for example, when the capacity pool 143 recovers (when the pool status constitutes “recovered”), the backup unit 513 updates the pool status 15115 in the thinned pool information 151 stored in the reserved area 171 to “recovered”.

Either when a pool VOL 145 is added to the capacity pool 143, or when a pool VOL 145 is deleted from the capacity pool 143 (Step 105: YES), the pool information 161 in the mapping management information 133 corresponding to this capacity pool 143 is updated. Therefore, in this case, the backup unit 513 updates the thinned pool information 151 stored in the reserved area 171 (Step 106). More specifically, for example, when one pool VOL 145 is added to the capacity pool 143, the backup unit 513 increases the value of the number of pool VOL 15113 by 1 in the thinned pool information 151 corresponding to this capacity pool 143, and adds the VOL # of the added pool VOL 145 to the pool VOL # list 1512. By contrast, for example, when one pool VOL 145 is deleted from the capacity pool 143, the backup unit 513 decreases the value of the number of pool VOL 15113 by 1 in the thinned pool information 151 corresponding to this capacity pool 143, and deletes the VOL # of the deleted pool VOL 145 from the pool VOL # list 1512.

When a virtual VOL 141 is associated to the capacity pool 143 (Step 107: YES), the virtual VOL information 163 corresponding to this capacity pool 143 is updated. Therefore, in this case, the backup unit 513 updates the thinned virtual VOL information 153 stored in the reserved area 171 of this capacity pool 143 (Step 112). More specifically, the backup unit 513 increases by 1 the value of the number of virtual VOL denoted by the header information 1531, and adds the virtual VOL unit information 1532.

When the 143 the virtual VOL 141 association to the capacity pool is deleted (Step 109: YES), the virtual VOL information 163 corresponding to this capacity pool 143 is updated. Therefore, in this case, the backup unit 513 updates the thinned virtual VOL information stored in the reserved area 171 of this capacity pool 143, and nullifies the virtual-page information element corresponding to the allocated real page (Step 110). More specifically, the backup unit 513 decreases by 1 the value of the number of virtual VOL denoted by the header information 1531, and deletes the virtual VOL unit information 1532 corresponding to the deleted virtual VOL 141. Further, the backup unit 513 nullifies the virtual-page information element corresponding to the virtual area of the deleted virtual VOL 141 (updates the null data) in the thinned mapping information 155.

When there is a change in the virtual VOL information 163 (Step 111: YES), the backup unit 513 updates the information element in the thinned virtual VOL information 153, which corresponds to the updated information element in the virtual VOL information 163 (Step 112).

When a real page is newly allocated in accordance with receiving a write request specifying an as-yet unspecified virtual page (Step 113: YES), the virtual-page information element, which denotes the allocation-target virtual page of this real page, is recorded in the entry corresponding to this real page in the mapping information 165. Therefore, in this case, the backup unit 513 adds this recorded virtual-page information element to the thinned mapping information 155 stored in the reserved area 171 (Step 114). More specifically, for example, if a sub-block area for recording the virtual-page information element newly written by the input/output controller 511 is not reserved in the cache memory 113, the backup unit 513 reserves this sub-block area in the cache memory 113. One sub-block is the size of a prescribed number of pages (for example, 32 pages), and is the transfer unit from the local memory 501 to the cache memory 113. The backup unit 513 reads this virtual-page information element from the entry in which the new virtual-page information element is recorded, and writes the read virtual-page information element to the reserved sub-block area in the cache memory 113. Thereafter, an input/output controller 511 destage job records a prescribed number (for example, 544) of virtual-page information elements comprising this virtual-page information element (may also include virtual-page information elements constituting null data) in an appropriate location in the thinned mapping information 155 stored in the reserved area 171.

The preceding is the flow of backup processing. Furthermore, typical determinations (Steps 101, 102, 103, 105, 107, 109, 111 and 113) carried out in a backup process are shown in FIG. 11, but determinations not shown in the figure may also be carried out. For example, when either the pool threshold or virtual VOL threshold is changed, either the pool threshold 15112 in the thinned pool information 151, or the virtual VOL threshold 15323 in the thinned virtual VOL information 153 is updated. In other words, if an information element, which is also comprised in the thinned mapping management information 135, is updated in the mapping management information 133, this information element will also be updated in the thinned mapping management information 135 stored in the reserved area 171 (and the nonvolatile storage resource 116 of the SVP 114). In other words, just because a certain information element has been updated in the mapping management information 133 does not mean that the entire thinned mapping management information 135 is updated, rather, only the same information element as the information element that was updated in the mapping management information 133 is updated in the thinned mapping management information 135.

FIG. 13 is a flowchart of the processing carried out in Step 104 of FIG. 11. Furthermore, the backup unit 513 formats the reserved area 171 prior to commencing this processing.

The backup unit 513 searches for the VOL # of a pool VOL by sequentially referring to the records of the first sub-table 181 of the association table 167 (Step 121).

Next, using the detected VOL # as a key, the backup unit 513 searches through the pool VOL directory 185 to find the memory bank address (Step 122). More specifically, the backup unit 513 specifies a record of the second sub-table 1851 in the pool VOL directory 185 from the second address corresponding to the detected VOL #. Then, the backup unit 513 specifies a record of the third sub-table 1853 in the pool VOL directory 185 from the third address recorded in the specified record. Consequently, the memory bank address recorded in this record is determined.

The backup unit 513 transfers to the cache memory 113 the virtual VOL # and virtual page # (may also constitute null data) recorded in the entry of the memory bank area specified from this memory bank address (Step 123). This processing is carried out for all the entries in this memory bank area (Step 124).

When the backup unit 513 has referenced all the records of the first sub-table 181 (Step 125: YES), Step 104 ends.

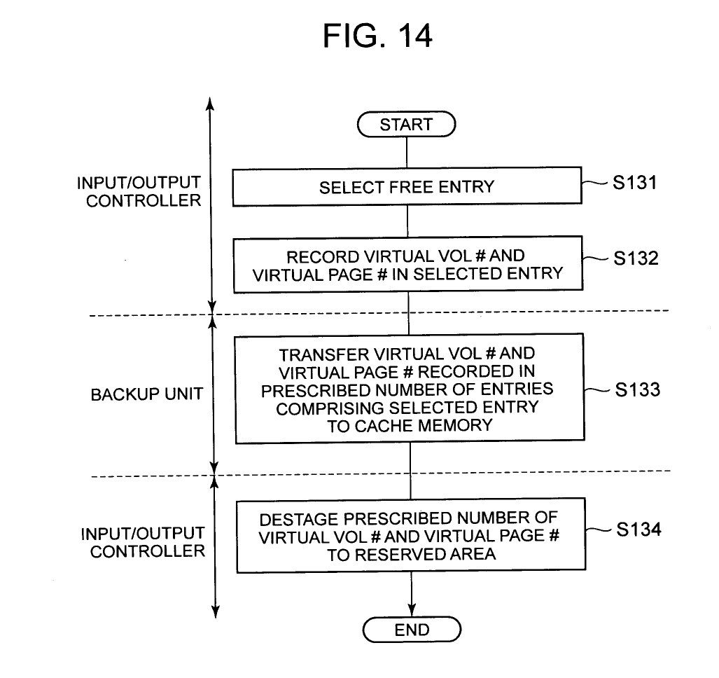

FIG. 14 is a flowchart of processing carried out when a real page is newly allocated to a virtual page.

The input/output controller 511 selects one entry from the free queue (the queue of entries corresponding to unallocated real pages) (Step 131). Then, the input/output controller 511 records the virtual VOL # and virtual page #, which correspond to the allocation-target virtual page of the real page corresponding to this entry, in the selected entry (Step 132).

The backup unit 513 transfers a prescribed number of the virtual VOL # and virtual page #, which are recorded in a prescribed number (for example, 32) of entries comprising this entry, to the reserved sub-block area in the cache memory 113 (Step 133).

The input/output controller 511, via a destage job, respectively writes (destages) a prescribed number (for example, 544) of virtual VOL # and virtual page # to corresponding reserved area 171 (Step 134).

Furthermore, in this processing, the backup unit 513 does not lock the virtual VOL # and virtual page # transferred to the cache memory 113 (More specifically, for example, the backup unit 513 immediately releases the lock after applying the lock one time.). This is because, if the virtual VOL # and virtual page # are locked in the cache memory 113, the virtual VOL # and virtual page # cannot be destaged, that is, cannot be backup up in the reserved area 171. By not locking the virtual VOL # and virtual page # transferred to the cache memory 113, the virtual VOL # and virtual page # can be backed up in the reserved area 171 as rapidly as possible.

The preceding is an explanation related to a backup process.

As described above, the mapping management information 133 can be restored in the shared memory 111 using the thinned mapping management information 135 backed up in the reserved area 171 (or nonvolatile storage device 116 of the SVP 114). A restore process, for example, is commenced when the power supply to the storage system 105 is turned ON.

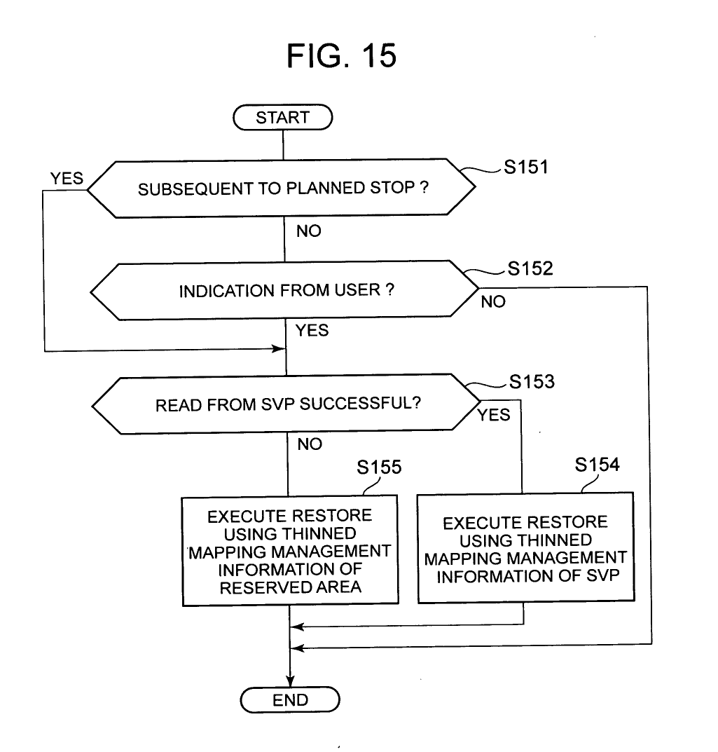

FIG. 15 is a flowchart of a restore process.

In Step 151, the restore unit 515 determines whether or not this restore process will occur subsequent to a planned stop. A planned stop is when the user intentionally stops the operation of the storage system 105. When this restore process occurs subsequent to a planned stop (for example, after the power has been turned OFF) (Step 151: YES), processing moves to Step 153, and when the restore process does not follow a planned stop (Step 151: NO), processing proceeds to Step 152.

In Step 152, the restore unit 515 determines whether or not an indication to restore the mapping management information 133 has been received from the user. When an indication to carry out a restore has been received (Step 152: YES), processing proceeds to Step 153, and when this indication has not been received (Step 152: NO), processing ends.

In Step 153, the restore unit 515 requests thinned mapping management information 135 from the SVP 114. Upon receiving thinned mapping management information 135 from the SVP 114 in response to this request (Step 152: YES), the restore unit 515 uses this thinned mapping management information 135 to restore the mapping management information 133 in the shared memory 111 (Step 154). Conversely, when the thinned mapping management information 135 is not received from the SVP 114 (Step 152: NO), the restore unit 515 executes a restore using the thinned mapping management information 135 stored in the reserved area 171 (Step 155).

According to this restore process, if this restore processing occurs subsequent to a planned stop, the restore is commenced automatically. This is because, in the case of a planned stop, power is supplied to the shared memory 111 via a prescribed power device from a primary power supply (for example, a commercial power supply) not shown in the figure, and therefore the backed up thinned mapping management information 135 corresponds to the latest mapping management information 133.

Conversely, if this restore process occurs subsequent to a stoppage that differs from a planned stop (for example, a stop caused by a power outage), a restore is commenced manually. This is because, in the case of a stoppage that differs from a planned stop, there is the possibility that power is not being supplied to the shared memory 111 via the prescribed power device from the primary power supply not shown in the figure, and therefore, there is the danger that the backed up thinned mapping management information 135 does not correspond to the latest mapping management information 133.

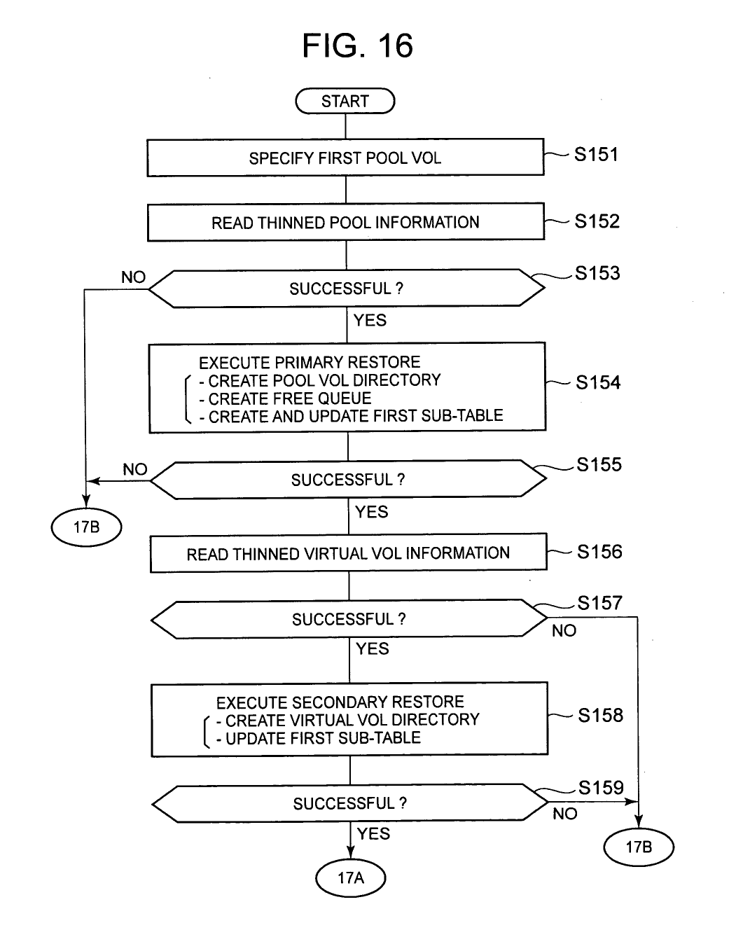

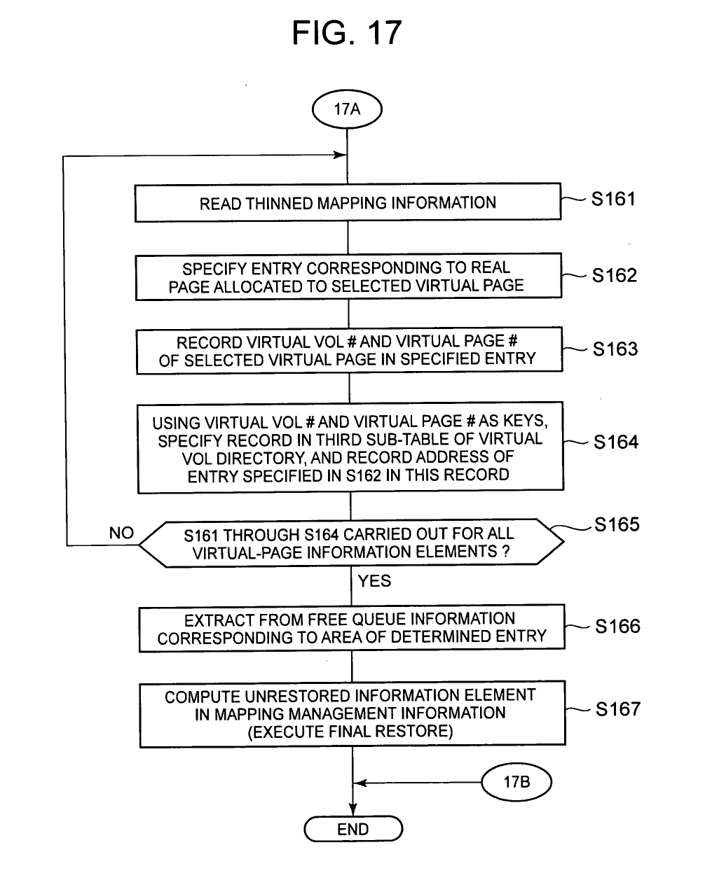

FIG. 16 shows the first part of a flowchart of processing (processing for one certain capacity pool 143) carried out in Step 155 of FIG. 15. FIG. 17 shows the second part of this flowchart.

The restore unit 515 specifies the first pool VOL from a plurality of pool VOL constituting the capacity pool 143 (Step 151).

The restore unit 515 reads the thinned pool information 151 from the reserved area 171, which is in the specified first pool VOL (that is, the reserved area 171 of the capacity pool 143) (Step 152).

If the read was successful (Step 153: YES), the restore unit 515 uses this thinned pool information 151 to execute a primary restore (Step 154). More specifically, for example, the restore unit 515 creates the pool VOL directory 185 in the shared memory 111 on the basis of the number of pool VOL 15113 in the thinned pool information 151. Further, the restore unit 515 prepares entries, which correspond to the real pages of the respective pool VOL, in the shared memory 111, and creates a free queue for these entries. The pool VOL # and real page # of the real pages corresponding to these entries are recorded in the prepared entries, but null data is recorded as the virtual VOL # and virtual page number #. The restore unit 515 also creates in the shared memory 111 a first sub-table 181, in which all the records are null data, and records the pool VOL #, which is recorded in the pool VOL # list 1512 in the thinned pool information 151, in this first sub-table 181.

If the primary restore is successful (Step 155: YES), the restore unit 515 reads the thinned virtual VOL information 153 from the reserved area 171 (Step 156).

If the read is successful (Step 157: YES), the restore unit 515 uses this thinned virtual VOL information 153 to execute a secondary restore (Step 158). More specifically, for example, the restore unit 515 creates the virtual VOL directory 183 in the shared memory 111 on the basis of the header information 1531 in the thinned virtual VOL information 153 (information denoting the number of virtual VOL). Further, the restore unit 515 records the virtual VOL #, which is comprised in the respective virtual VOL unit information 1532 in the thinned pool information 151, in the first sub-table 181.

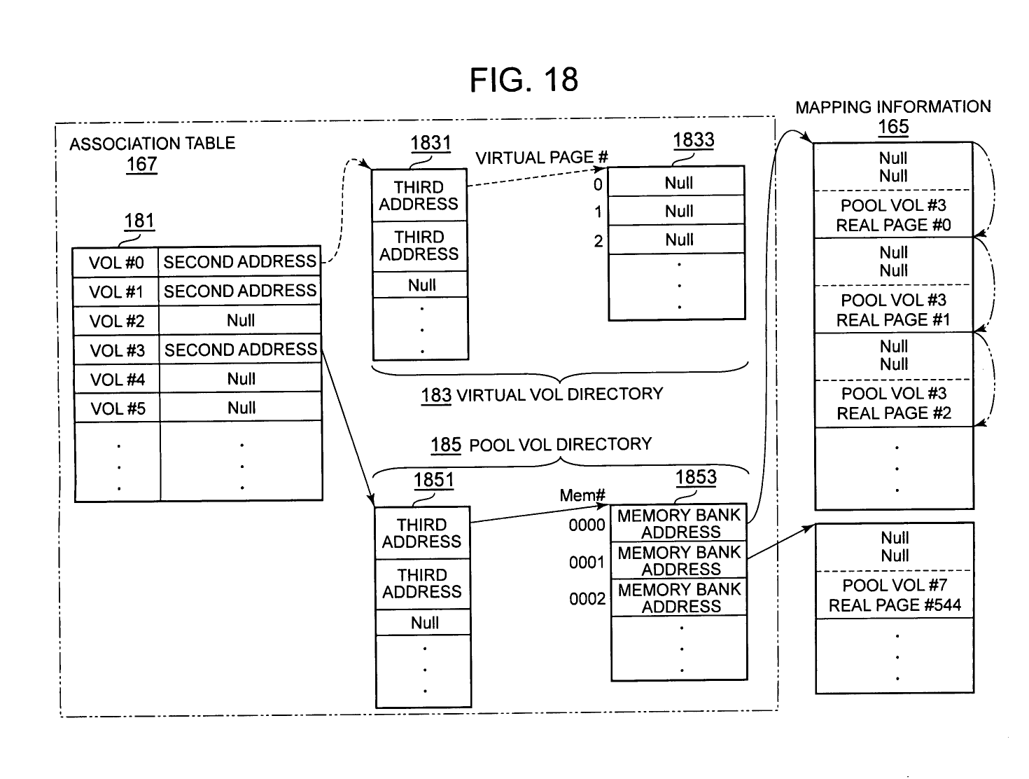

If the execution of the secondary restore is successful (Step 159: YES), processing moves to Step 161 of FIG. 17. The association table 167 and mapping information 165 at the time the secondary restore ends are shown in FIG. 18. According to FIG. 18, all the pool VOL # constituting the capacity pool 143, and the virtual VOL # of all the virtual VOL associated to this capacity pool 143 are recorded in the first sub-table 181. Further, the pool VOL # and real page # of the corresponding real pages are recorded in the respective entries constituting the mapping information 165, but null data is recorded as the virtual VOL # and virtual page #. Thus, all the entries belong to the free queue (refer to the dotted-line arrows of FIG. 18). Further, since null data is recorded in all the records of the third sub-table 1833 in the virtual VOL directory 183, there is no association to the entries of the mapping information 165.

In Step 161 of FIG. 17, the restore unit 515 reads the thinned mapping information 155 from the reserved area 171.

In Step 162, the restore unit 515 selects one set of a virtual VOL # and virtual page # from the thinned mapping information 155 (that is, the restore unit 515 selects a virtual page). The restore unit 515 specifies the pool VOL # and real page #, which correspond to the location (order) of the selected virtual VOL # and virtual page #. Using the specified pool VOL # and real page # to reference the first sub-table 181 and pool VOL directory 185, the restore unit 515 specifies the entry, which corresponds to the real page of this pool VOL # and real page #.

In Step 163, the restore unit 515 records the virtual VOL # and virtual page #, which were selected in Step 162, in the entry specified in Step 162.

In Step 164, using the virtual VOL # and virtual page # selected in Step 162 to reference the first sub-table 181 and the virtual VOL directory 183, the restore unit 515 specifies a record of the third sub-table 1833 in the virtual VOL directory 183. Then, the restore unit 515 records the address of the entry specified in Step 162 in this record.

Steps 161 through 164 described above are carried out for all the virtual VOL # and virtual page # (except for those constituting null data) in the thinned mapping information 155 (Step 165).

Thereafter, the restore unit 515 extracts the entry in which the virtual VOL # and virtual page # are recorded from the free queue (Step 166).

Further, the restore unit 515 restores the unrestored information elements in the mapping management information 133 (Step 167). More specifically, for example, based on the restored mapping information 165, the restore unit 515 computes the pool utilization rate of the pool information 161, and/or computes the virtual VOL utilization rate of the virtual VOL information 163.

In accordance with the series of processes explained by referring to FIGS. 16 and 17, the mapping management information 133 is restored to the shared memory 111.

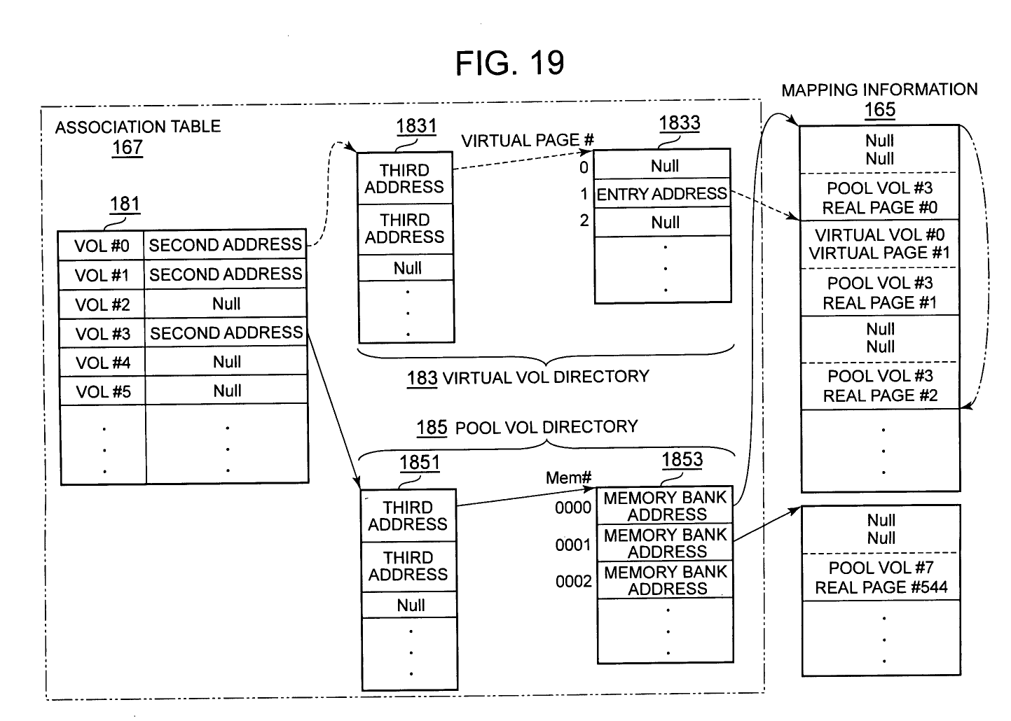

FIG. 19 shows the association table 167 and mapping information 165 at the point when Step 167 of FIG. 17 ends. As is clear from comparison with FIG. 18, for the virtual page to which the real page is allocated, the virtual VOL # and virtual page # of this virtual page are recorded in the entry in the mapping information 165. Further, the address of the entry, in which this virtual VOL # and virtual page # are recorded (the entry corresponding to the real page allocated to the virtual page), is recorded in the third sub-table 1833 record, which corresponds to this virtual page.

The preferred embodiment of the present invention has been explained hereinabove, but this is an example for explaining the present invention, and does not purport to limit the scope of the present invention solely to this embodiment. The present invention can be put into practice in a variety of other modes as well.

What is claimed is:

1. A storage system, which provides a virtual volume constituted from a plurality of virtual areas, comprising:
a plurality of nonvolatile physical storage devices;
a plurality of real areas, which constitute a capacity pool created on the basis of storage areas of the plurality of physical storage devices;
a volatile memory for storing mapping information, which denotes which real area correspond to which virtual area;
an input/output controller, which, upon receiving a write request from a computer, updates the mapping information to information denoting that a real area, which has been selected from one or more unallocated real areas, is allocated to the virtual area specified in the write request, and writes data conforming to the write request to the allocated real area; and
a backup unit for writing either all or part of the mapping information stored in the volatile memory to a nonvolatile storage area.

2. The storage system according to claim 1, further comprising a restore unit, which uses a portion of the mapping information stored in the nonvolatile storage area to restore the mapping information,
wherein the backup unit writes an information element required to restore the mapping information to the nonvolatile storage area as a portion of the mapping information.

3. The storage system according to claim 2, wherein the mapping information comprises a real-area information element denoting a real area, and a virtual-area information element denoting the allocation-target virtual area of this real area for each real area, and
the backup unit writes the plurality of virtual-area information elements, from among the plurality of real-area information elements and plurality of virtual-area information elements, to the nonvolatile storage area.

4. The storage system according to claim 3, wherein the restore unit restores the mapping information to the volatile memory by executing processes (1) through (4) below:
(1) a process for creating in the volatile memory respective entry areas, which store the respective real-area information elements corresponding to the respective real areas;
(2) a process for reading the plurality of virtual-area information elements from the nonvolatile storage area;
(3) a process for specifying which real areas are allocated to the respective virtual areas corresponding to the respective virtual-area information elements, based on the order of the respective virtual-area information elements in the read plurality of virtual-area information elements; and
(4) a process for writing to an entry area corresponding to the specified real area a virtual-area information element denoting the allocation-target virtual area of this real area.

5. The storage system according to claim 3, wherein
a plurality of the capacity pools exist,
the respective capacity pools have a reserved area, which is a pre-reserved storage area that differ from the plurality of real areas,
the reserved area is treated as the nonvolatile storage area,
the mapping information is constituted from sub-mapping information, which corresponds to the respective capacity pools,
the sub-mapping information comprises a real-area information element denoting a real area, and a virtual-area information element denoting the allocation-target virtual area of this real area, for each real area constituting the capacity pool corresponding to this sub-mapping information, and
the backup unit writes the plurality of virtual-area information elements, from among the plurality of real-area information elements and plurality of virtual-area information elements, which constitute the sub-mapping information, to the reserved area in the capacity pool corresponding to this sub-mapping information.

6. The storage system according to claim 5, wherein the restore unit restores the sub-mapping information for the respective capacity pools in the volatile memory by executing processes (1) through (4) below for each capacity pool:
(1) a process for creating in the volatile memory respective entry areas, which store the respective real-area information elements corresponding to the respective real areas constituting the capacity pool;
(2) a process for reading the plurality of virtual-area information elements from the reserved area;
(3) a process for specifying which real areas in the capacity pool are allocated to the respective virtual areas corresponding to the respective virtual-area information elements, based on the order of the respective virtual-area information elements in the read plurality of virtual-area information elements; and
(4) a process for writing to the entry area corresponding to the specified real area a virtual-area information element denoting the allocation-target virtual area of this real area.

7. The storage system according to claim 3, wherein
the capacity pool is constituted from one or more
pool volumes, which are one or more logical volumes of a plurality of logical volumes created on the basis of the storage areas of the plurality of physical storage devices,
the volatile memory further stores pool information, which is information related to the capacity pool, and virtual volume information, which is information related to a virtual volume, which is associated to a capacity pool, from among a plurality of virtual volumes,
the pool information comprises pool volume identification information for identifying a pool volume, which constitutes the capacity pool,
the virtual volume information comprises virtual volume identification information for identifying a virtual volume associated to the capacity pool, and
the backup unit writes the pool volume identification information to the nonvolatile storage area as a portion of the pool information, and writes the virtual volume identification information to the nonvolatile storage area as a portion of the virtual volume information.

8. The storage system according to claim 7, wherein, when a new capacity pool is created, the backup unit writes pool volume identification information for identifying a pool volume, which constitutes this capacity pool, to the nonvolatile storage area.

9. The storage system according to claim 7, wherein, when a new virtual volume is associated with the capacity pool, the backup unit adds the virtual volume identification information of the newly associated virtual volume to the nonvolatile storage area.

10. The storage system according to claim 7, wherein, when the association of a virtual volume with the capacity pool is deleted, the backup unit nullifies the virtual volume identification information of the virtual volume for which the association is deleted, and the virtual-area information element denoting the virtual area constituting this virtual volume, which are stored in the nonvolatile storage area.

11. The storage system according to claim 7, wherein, when a status related to the capacity pool changes, the backup unit writes the post-change status to the nonvolatile storage area as a portion of the pool information.

12. The storage system according to claim 7, wherein the restore unit restores the mapping information in the volatile memory by executing processes (1) through (6) below:
(1) a process for reading the pool volume identification information from the nonvolatile storage area, and, based on the pool volume identification information, creating in the volatile memory a pool directory, which is a storage area corresponding to the pool volume, and the respective entry areas, which store the respective real-area information elements corresponding to the respective real areas constituting this pool volume;
(2) a process for reading the virtual volume identification information from the nonvolatile storage area, and, based on the virtual volume identification information, creating in the volatile memory a virtual volume directory, which is a storage area corresponding to the virtual volume;
(3) a process for reading the plurality of virtual-area information elements from the nonvolatile storage area;
(4) a process for specifying which real areas in the capacity pool are allocated to the respective virtual areas corresponding to the respective virtual-area information elements, based on the order of the respective virtual-area information elements in the read plurality of virtual-area information elements;
(5) a process for writing to the entry area corresponding to the specified real area a virtual-area information element denoting the allocation-target virtual area of this real area; and
(6) a process for writing an address of the entry area corresponding to the specified real area to a sub-directory, which is specified from the virtual-area information element denoting the allocation-target virtual area of this real area, in the virtual volume directory.

13. The storage system according to claim 3, wherein, when in accordance with a real area being allocated to a virtual area, for which a real area is not allocated, the virtual-area information element, which denotes the allocation-target virtual area in the real-area information element denoting the allocated real area, is written to the mapping information, the backup unit writes the written virtual-area information element to the nonvolatile storage area.

14. The storage system according to claim 3, further comprising a cache area for temporarily storing data, which is written to each of the plurality of physical storage devices, wherein
the nonvolatile storage area is the storage area of one or more physical storage devices from among the plurality of physical storage devices, and
the backup unit writes to the cache area a group of information elements of information transfer unit size comprising a virtual-area information element, which has been written to the mapping information, and writes the group of information elements from the cache area to the nonvolatile storage area, which is the storage area of the one or more physical storage devices.

15. The storage system according to claim 3, further comprising a microprocessor, wherein
if a computer program comprising the backup unit is installed as a computer program to be executed by the microprocessor, the microprocessor executes the installed computer program, thereby writing the respective virtual-area information elements stored in the volatile memory to the nonvolatile storage area.

16. The storage system according to claim 2, wherein, when power is supplied to the volatile memory from a primary power source, the restore unit executes a restore without receiving an indication from a user.

17. The storage system according to claim 2, wherein, when power is not supplied to the volatile memory from the primary power source, the restore unit executes a restore upon receiving an indication from the user.

18. The storage system according to claim 2, wherein
the backup unit transfers a portion of the backup information to the nonvolatile storage area as well as an information processing device comprising a nonvolatile storage device, and
when read of a portion of the mapping information from the information processing device is successful, the restore unit restores the mapping information on the basis of this portion of the mapping information, and when the read of the portion of the mapping information from the information processing device fails, the restore unit reads the portion of the mapping information from the nonvolatile storage area.

19. A virtualization system, which provides a virtual volume constituted from a plurality of virtual areas, comprising:
a volatile memory for storing mapping information denoting which real area, from among a plurality of real areas constituting a capacity pool created on the basis of the storage areas of a plurality of physical storage devices, corresponds to which virtual area;
an input/output controller, which, upon receiving a write request from a computer, updates the mapping information to information denoting allocation of a real area, which is selected from one or more unallocated real areas, to the virtual area specified by the write request, and writes data conforming to the write request to the allocated real area; and
a backup unit for writing either all or part of the mapping information, which is stored in the volatile memory, to a nonvolatile storage area.

20. A storage control method which is executed in a system having a function for providing a virtual volume, which is constituted from a plurality of virtual areas; and a volatile memory for storing mapping information denoting which real area, from among a plurality of real areas constituting a capacity pool created on the basis of the storage areas of a plurality of physical storage devices, correspond to which virtual area,
this method comprising the steps of:
updating, upon receiving a write request from a computer, the mapping information to information denoting allocation of a real area, which is selected from one or more unallocated real areas, to the virtual area specified by the write request, and writing data conforming to the write request to the allocated real area; and
writing either all or part of the mapping information, which is stored in the volatile memory, to a nonvolatile storage area.
